(19) United States
(12) Patent Application Publication
(10) Pub. No.: US 2026/0186650 A1
(43) Pub. Date: Jul. 2, 2026

(54) B+Tree Based Data Management Method and Electronic Device

(71) Applicant: HANGZHOU HIGH-TECH ZONE (BINJIANG) INSTITUTE OF BLOCKCHAIN AND DATA SECURITY, Hangzhou (CN)

(72) Inventors: Hao Duan, Hangzhou (CN); Xiaojing Li, Hangzhou (CN); Yang Sun, Hangzhou (CN); Fanshu Tang, Hangzhou (CN); Cuihua Yang, Hangzhou (CN); Weifeng Sheng, Hangzhou (CN); Chao Yuan, Hangzhou (CN)

(21) Appl. No.: 19/430,554

(22) Filed: Dec. 23, 2025

(30) Foreign Application Priority Data
Jan. 2, 2025 (CN) 202510002587.8

(51) Int. Cl. G06F 3/06

(52) U.S. Cl. CPC G06F 3/0604; G06F 3/0655; G06F 3/0679

(57) ABSTRACT

A B+-tree-based data management method includes writing, when a first write operation on a node data of a B+ tree is detected, the node data to a base page of a disk, wherein the base page contains a pointer field configured to indicate an associated delta page; creating a first delta record in a delta page based on the base page, when a first write operation on a target entry in the base page is detected; creating a second delta record in the delta page when a second write operation on the target entry is detected, the second delta record is used to record second data corresponding to the second write operation. Accordingly, a waste of disk space may be reduced, and complexity of read-write operations may be lowered.

### CROSS-REFERENCE TO RELATED APPLICATION

This application claims priority to Chinese Patent Application No. 202510002587.8 filed Jan. 2, 2025, the disclosure of which is hereby incorporated by reference in its entirety.

### BACKGROUND

### Technical Field

The present disclosure pertains to the field of data processing technologies, and more particularly, to a B+-tree-based data management method and an electronic device.

### Technical Considerations

A B+ tree is a balanced tree data structure that serves as a multi-way sorting tree where each node generally contains a plurality of child nodes. The B+ tree is widely used in databases and file systems due to its efficient range query and sequential access capabilities. By organizing node data into disk pages with fixed-sizes, the B+ tree achieves efficient storage and persistence of large amount of data.

In practical applications, B+ trees often adopt a copy on write (Copy on Write, COW) technique to ensure data consistency and support multi-version transactions. That is, when data in a node is modified, the node is first copied to a new location, then, data modification is completed on a copy of the node. The data modification is only associated with a small amount of updates, however, copying of the entire disk pages is required. Thus, a waste of disk space is caused and read-write complexity is increased.

### SUMMARY

According to various non-limiting embodiments of the present disclosure, a B+-tree-based data management method and an electronic device are provided to reduce waste of disk space and lower the complexity of read-write operations.

In accordance with the first non-limiting aspect, a B+-tree-based data management method is provided in the non-limiting embodiments of the present disclosure. The method includes following operations:
writing, when a first write operation on a node data of a B+ tree is detected, the node data to a base page of a disk, the base page contains a pointer field configured to indicate an associated delta page; creating, when a first write operation on a target entry in the base page is detected, a first delta record in a delta page based on the base page, the first delta record is used to record first data corresponding to the first write operation, and a first pointer of the target entry in the base page points to first address information of the first delta record; creating, when a second write operation on the target entry is detected, a second delta record in the delta page, the second delta record is used to record second data corresponding to the second write operation, the first pointer of the target entry in the base page points to second address information of the second delta record, and a second pointer of the second delta record points to the first address information of the first delta record. The pointer field is configured to indicate the delta page associated with the base page.

According to this method, the target entry of the base page includes a first pointer. When performing a write operation on the data of the target entry, the update operation on the data of the base page is recorded through a delta page approach. Additionally, the first pointer in the target entry of the base page always points to the address information of the latest delta page subsequent to an execution of each write operation. During data updating, there is no need to traverse and copy the linked list data of the entire disk page. Instead, the latest incremental data may be directly located, a waste of disk space is alleviated, and the complexity of read-write operations is lowered. According to the method of the present disclosure, good usability and practicality are achieved.

In some non-limiting embodiments, the method further includes a following operation:
creating a mapping table corresponding to the base page when the node data is written into the base page of the disk. The mapping table is used to record a correspondence relationship between data of the target entry in the base page and address information in the delta page.

In some non-limiting embodiments, subsequent to the operation of creating the first delta record in the delta page, the method further includes a following operation:
recording a mapping relationship between the target entry and the first delta record in the mapping table. The mapping relationship includes the first address information of the first delta record.

Subsequent to the operation of creating the second delta record in the delta page, the method further includes a following operation:
updating the first address information in the mapping relationship to the second address information of the second delta record.

In some non-limiting embodiments, the method further includes a following operation:
merging data recorded in the base page with data recorded in the delta page to obtain a new base page, in accordance with a determination that a number of mapping relationship(s) recorded in the mapping table exceeds a first threshold.

In some non-limiting embodiments, the method further includes a following operation:
merging data recorded in the base page with data recorded in the delta page to obtain a new base page, in accordance with a determination that a size of the delta page exceeds a second threshold.

In some non-limiting embodiments, the operation of merging the data recorded in the base page with the data recorded in the delta page includes:
merging the data recorded in a latest delta record corresponding to the target entry in the delta page into the base page to obtain the new base page.

In some non-limiting embodiments, the operation of merging the data recorded in the base page with the data recorded in the delta page includes following operations:
determining a latest delta record corresponding to the target entry in the delta page based on the address information recorded in the mapping table; and
merging data recorded in the latest delta record into the base page to obtain the new base page.

In some non-limiting embodiments, subsequent to the operation of merging the data recorded in the base page with the data recorded in the delta page to obtain the new base page, the method further includes following operations:
performing a splitting operation on the node data of a current node in accordance with a determination that a size of the new base page exceeds a third threshold;
writing data split based on the splitting operation into a newly added node; and
updating index information of the newly added node in a parent node of the current node.

In accordance with the second non-limiting aspect, an electronic device is provided in the present disclosure. The electronic device includes at least one processor and a storage communicatively connected to the at least one processor; the storage stores a computer program executed by the at least one processor. The computer program is configured to, when executed by the at least one processor, cause the at least one processor to perform the method described in the first aspect.

In accordance with the third non-limiting aspect, a chip system is provided in the present disclosure, the chip system is applied to an electronic device. The chip system includes one or a plurality of processors, and the one or a plurality of processors are configured to invoke a computer instruction to cause the electronic device to perform the method described in the first aspect.

In accordance with the fourth non-limiting aspect, a non-transitory computer-readable storage medium is provided in the present disclosure, the non-transitory computer-readable storage medium stores a computer program that, when executed by a processor of an electronic device, cause the electronic device to implement the method described in the first aspect.

In accordance with the fifth non-limiting aspect, a computer program product is provided in the present disclosure, when the computer program product is executed on the electronic device, the electronic device is caused to perform the method described in the first aspect.

It should be appreciated that regarding the beneficial effects of the second aspect, the third aspect, the fourth aspect, the fifth aspect, reference can be made to the relevant descriptions in the first aspect. These beneficial effects are not repeatedly described herein.

### BRIEF DESCRIPTION OF THE DRAWINGS

In order to describe the non-limiting embodiments of the present disclosure or the existing technologies more clearly, a brief introduction regarding the accompanying drawings that need to be used for describing the embodiments or the existing technologies is given below. It is obvious that the accompanying drawings described below are merely some embodiments of the present disclosure, a person of ordinary skill in the art may also acquire other drawings according to these drawings without paying creative works.

FIG. 1 is a schematic diagram of an architecture of a B+ tree storage model provided in a non-limiting embodiment of the present disclosure;

FIG. 2 is a schematic diagram of a single linked list structure of a target entry in a delta page in accordance with a non-limiting embodiment of the present disclosure;

FIG. 3 is a schematic diagram illustrating an implementation process of a B+-tree-based data management method in accordance with a non-limiting embodiment of the present disclosure;

FIG. 4 is a schematic diagram of an overall architecture for updating data in accordance with a non-limiting embodiment of the present disclosure; and

FIG. 5 is a schematic block diagram of an electronic device provided in a non-limiting embodiment of the present disclosure.

### DETAILED DESCRIPTION

The technical solutions in the non-limiting embodiments of the present disclosure will be described in detail with reference to the accompanying drawings. The following embodiments are only used to illustrate the technical solutions of the present disclosure more clearly, and therefore serve as examples only, and should not constitute as limitations on the scope of protection of the present disclosure.

Unless otherwise defined, all technical and scientific terms used herein have the same meaning as normally understood by the person skilled in the art. The terms used in the present disclosure are only for the purpose of describing specific embodiments and are not intended to limit the present disclosure. The terms “includes” and “has” in the description and the claims, and the description of the drawings of the present disclosure and any variation of these terms, are intended to contain non-exclusive inclusion.

In the description of the embodiments of the present disclosure, technical terms, such as “first”, “second”, etc., are only used to distinguish different objects and hence cannot be interpreted as indicating or implying relative importance or implicitly specifying the number, the specific order, or the primary and secondary relationships of the indicated technical features. In the description of the embodiments of the present disclosure, the term “a plurality of” is indicative of two or more than two, unless otherwise this term is explicitly and specifically limited.

“Embodiments” mentioned in the present disclosure means that a particular feature, structure or characteristic described with reference to the embodiments may be included in at least one embodiment of the present disclosure. The occurrence of the phrase at various parts in the specification does not necessarily refer to the same embodiment, nor is it a separate or alternative embodiment being mutually exclusive with other embodiments. It should be appreciated, both explicitly and implicitly, by the person of ordinary skill in the art that the embodiments described herein may be combined with other embodiments.

In the descriptions of the present disclosure, the term “and/or” is only used to describe an association relationship of an associated object, which indicates that there may be three relationships. For example, A and/or B may represent three conditions: A exists alone, A and B coexist, B exists alone. In addition, the character “/” in the present disclosure generally indicates that there exists an “alternative” relationship between two consecutive associated objects.

B+ tree achieves efficient storage and persistence of large amount of data by organizing node data into disk pages with fixed size. In practical applications, the B+ tree often adopt a copy on write (Copy on Write, COW) approach to ensure data consistency and support multi-version transactions. However, data modifications often involve only a small number of updates, but require the entire disk pages to be copied, Thus, there exists a write amplification issue, and a large amount of redundant data is generated, a waste of disk space is caused accordingly. Each time a new version of data is generated, the process of copying and writing node data to the disk increases the burden on read and write performance. Moreover, each update of node data may affect parent nodes and root nodes, thereby leading to rewriting of multi-level nodes and increasing write costs.

Currently, the related technologies include using an approach of delta page (Delta Page) to record update operations to disk page data, and appending each updated Delta Page before the base page, thereby reducing input/output (Input/Output, I/O) operations to the disk, and simplifying data management during subsequent data merging operation.

Based on this approach, whenever a data modification occurs during a disk operation, a new current delta page is generated. All currently updated data is written to the current delta page, and a delta page identifier field in the base page is updated with an identifier of the current delta page. When data updates are frequently performed and multiple data are updated each time, the generated delta pages form a long chain. Each time data is read, the entire delta page chain list needs to be traversed to construct a latest data structure view. Thus, a complexity of a read operation is significantly increased and a read performance is weakened. Subsequently, the read performance may be improved by merging data of delta pages. However, when data amount of these delta pages is large, resource contention may occur, and a transient performance degradation of the system may be caused.

Aiming at the aforesaid technical problem, B+-tree-based data management method is provided in the non-limiting embodiments of the present disclosure. In this method, updated data is stored in a delta page manner and pointer fields are added to the plurality of entries in the base page within the B+ tree storage model to indicate the latest delta records in the delta page. In a case where data is updated, there is no need to copy the entire disk page data. In a case where data is read, the latest data may be quickly located based on the pointer fields of the plurality of entries in the base page. Accordingly, complexity of disk read-write operations is reduced, and disk read-write performance is improved.

The specific implementation process of the B+-tree-based data management method in accordance with the non-limiting embodiments of the present disclosure is described below.

Referring to FIG. 1, FIG. 1 is a schematic diagram illustrating an architecture of the B+ tree storage model in accordance with a non-limiting embodiment of the present disclosure. During a data storage process of the B+tree, node data of the B+ tree is stored in the disk in the form of pages. A node may be an abstraction of a disk page in the B+ tree, which represents a data structure that has been deserialized and loaded into a memory.

B+ tree has a balanced tree structure, is used for indexing in databases and file systems. A disk page is a physical unit for data storage. In databases, data is stored on disk in page units, with a fixed page size, such as 4 KB, 8 KB, etc. A node in the B+ tree is a logical unit within the B+ tree structure, is used to store key values and pointers to child nodes. In the memory, a disk page is read from the disk and loaded into the memory, this disk page is abstracted as a node in the B+ tree. When a node in the B+ tree needs to be persisted to the disk, the node is serialized into a byte stream and then stored in one or a plurality of disk pages. When reading node data of the B+ tree from the disk, the corresponding disk page is read into memory and is deserialized into the node data structure of the B+ tree. Due to limited memory space, only an accessed node or an adjacent node of the accessed node is loaded into the memory. In a case where a node needs to be accessed, and this node is not in memory, the database may read the corresponding page (i.e., the physical storage form of the node) from the disk first, and then deserialize this page into the node data structure in memory.

In the storage model of the B+ tree, in a case where node data is first written from the memory to the disk for persistent storage, the node data is solidified into a fixed base state which can be referred to as a base page (Base Page). Subsequent data update and other operations are extended and managed based on the base page.

As shown in FIG. 1, the base page may include a newly added field (dp), a current page representation (id), a number of key-value pairs (count), a number of overflow pages (overflow), and a byte array (data) for storing page contents. The newly added field (dp), the current page representation (id), the number of key-value pairs (count), and the number of overflow pages (overflow) are constituted as page header data (Page Header) of the base page. The newly added field is used to indicate a pointer field configured to indicate an associated delta page. The byte array (data) includes all stored entries, such as a first entry (inode-1), a second entry (inode-2), etc.

As an example, a data structure of a node of the B+ tree may include a disk page identifier (pgid) corresponding to the current node, a key (or key value) of the current node, and all entries (inodes) stored in the current node. Where, inode represents a single entry stored in the node, and a data structure of the single entry includes a pointer field (next), a stored key value, an identifier (pgid) indicating the target page, a flag of the current node, and a value associated with the key. Entries are used to provide index information for related data.

The pointer field is used to indicate address information of the delta page; the stored key value is used to indicate sorting based on the key value, thus supporting efficient operations including searching, inserting, and deleting nodes. The identifier indicating the target page is used to record a child node indicated by an internal node. The flag of the current node is used to determine whether the current node is a leaf node or a non-leaf node by marking. If the current node is a leaf node, the value field stores the value associated with the key accordingly. If the current node is an internal node (i.e., the non-leaf node), the value field is not used, and data is stored in the child node through the identifier (pgid) indicating the target page.

Correspondingly, in the structure of the base page and the storage model on the corresponding disk shown in FIG. 1, the representations of the various fields (e.g., next, key, pgid, flags, and value) in the various entries are identical to the corresponding representations in the node data structure, respectively. The header data of the base page corresponds to the attribute of the base page, and header data of the delta page corresponds to the attribute of the delta page.

As shown in FIG. 1, the newly added field (dp) in the base page is used to indicate a delta page associated with the base page, and the delta page is used to store all incrementally updated data on that node. When data of an entry in the base page changes (e.g., the data of the first entry inode-1 changes), a new delta record (e.g., inode-1′) is created in the corresponding delta page, and the pointer field (next) of the first entry in the base page indicates position information of the delta record in the delta page, such as an offset position (Offset Position).

When multiple changes are made to the data, if the data of the first entry is changed again, an additional delta record (such as inode-1″) is added to the delta page, and the address information pointed by the pointer of the first entry inode-1 is updated so that the pointer points to the address information of the delta record inode-1″, such as the offset position (Offset Position) of the delta record inode-1″. Similarly, when the data of the first entry is changed again, an additional delta record (e.g., inode-1″′) is added to the delta page, and the pointer of the first entry inode-1 is updated to point to the position information (e.g., the offset position) of the delta record inode-1″′. In this way, it is ensured that the pointer of the first entry always points to the data in the latest delta record.

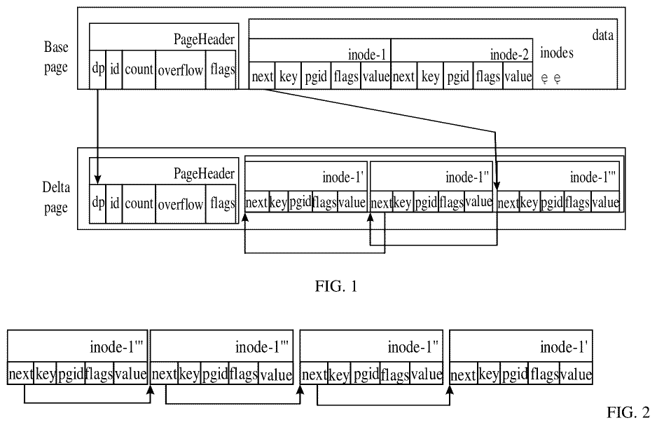

Correspondingly, with multiple change operations, the updated data corresponding to the plurality of entries in the delta page forms a singly linked list structure, each delta record in the list is linked to a previous version. For example, a pointer of inode-1″′ indicates a offset position of the delta record inode-1″, and a pointer of inode-1″′ indicates an offset of the delta record inode-1′. As shown in FIG. 2, the first entry inode-1 in the base page corresponds to the single linked list structure in the delta page. Since the next pointer of the first entry inode-1 always points to the latest delta record, there is no need to traverse all hierarchical linked lists of the delta page for read operation, instead, the data of the latest delta record can directly located. Thus, an efficiency of the read operation is improved significantly.

In some non-limiting embodiments, in case of updating data for other entries in the base page, the implementation principle of updating data for other entries in the base page is the same as the implementation principle mentioned above.

Based on the architecture of the aforesaid storage model, the specific implementation process of the B+-tree-based data management method are further described with reference to the embodiments hereinafter.

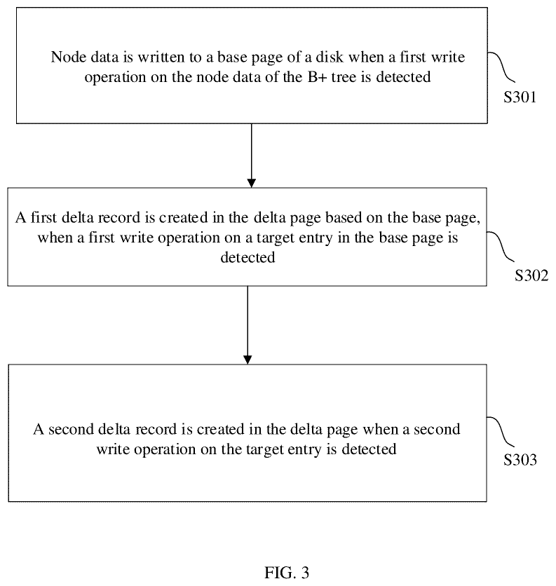

Referring to FIG. 3, FIG. 3 illustrates a schematic implementation flow of the B+-tree-based data management method in accordance with a non-limiting embodiment of the present disclosure. An executive subject of this method may be an electronic device including a database or a file system. This method may include the following steps:
In a step of S301, node data is written to a base page of a disk when a first write operation on the node data of the B+ tree is detected. The base page contains a pointer field configured to indicate an associated delta page.

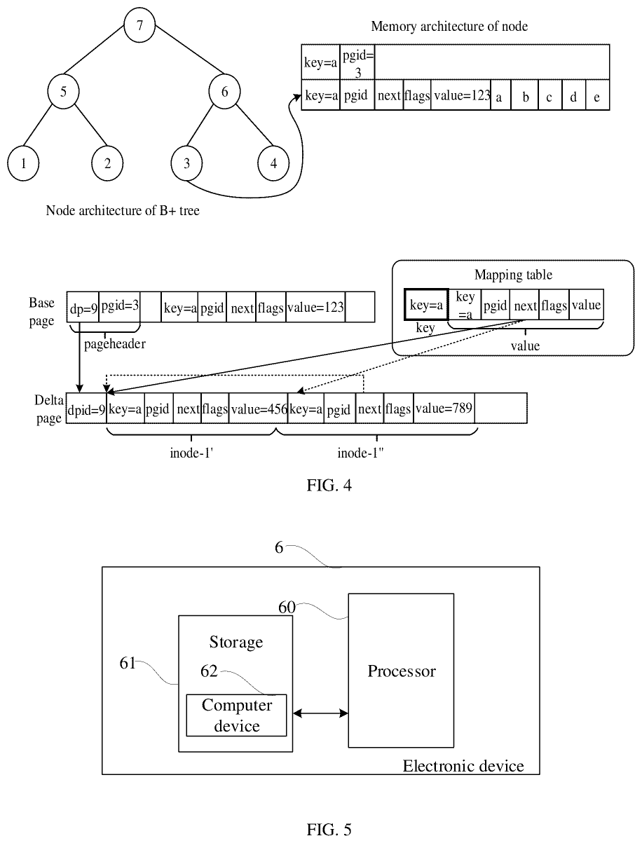

In this embodiment of the present disclosure, each tree node contains a set of key-value pairs in the B+ tree. The key is used for sorting and retrieving data, while the value is the corresponding data. As shown in FIG. 4, a node architecture of the B+ tree corresponds to a memory architecture of the node. A node 3 includes a key (key): a (data entry or object). The corresponding data of the value includes: the corresponding disk page identifier pgid=3, the pointer field next, the node type flags, and the specific data value=123. In the memory, node data may exist in the form of the data structure described above.

In some non-limiting embodiments, before writing node data from the memory to the disk for the first time, the structure of the node data in memory is serialized into a continuous byte stream, and the disk is divided into pages with fixed size. The continuous byte stream is written into the corresponding disk page using input/output (I/O) operations of the database or the file system, and the node data is solidified into a fixed base state. This base state is referred to as the state of the base page of data storage. The base page is a persistent representation of the node data in the disk. As shown in FIG. 4, the base page includes a key (key=3) in the node data, the corresponding disk page identifier (pgid=3), the pointer field next, the node type flags, and the specific data value=123.

A size of a node may be less than or equal to a size of a disk page, which ensures that the node data can be stored entirely within a single disk page. During subsequent data update (e.g., writing data), data expansion and management are performed based on the base page.

In some non-limiting embodiments, this method further includes:
when writing the node data to the base page of the disk, a mapping table corresponding to the base page is created. The mapping table is used to record a correspondence relationship between data of target entries in the base page and address information in the delta page.

In some non-limiting embodiments, referring to the mapping table (Mapping Table) shown in FIG. 4, the mapping table represents the correspondence relationship between the plurality of entries (such as key=a) in the base page and the delta records in the delta page in the form of key-value pairs. The value in this correspondence relationship includes the address information of the delta record corresponding to the entries in the delta page. This address information may be represented by the pointer field next.

When data on the base page is not updated, various fields included in the value of the mapping table may be empty. Correspondingly, the mapping table records a mapping relationship corresponding to the updated entry subsequent to an execution of a data update operation.

In a step of S302, a first delta record is created in the delta page based on the base page, when a first write operation on a target entry in the base page is detected.

In the embodiments of the present disclosure, an entry refers to a data structure used to manage files or directories in the file system, and is used to store information related to files or directories. As shown in FIG. 1, the first entry inode-1 and the second entry inode-2 in the base page contain various field information, the target entry is any entry of data to be updated in the base page.

In some non-limiting embodiments, when a data update operation corresponding to the target entry of the base page, such as the first write operation for writing first data into the target entry, is received by the electronic device, the electronic device creates a delta page corresponding to the target entry based on the base page, and creates a delta record (e.g., the first delta record inode-1′) in the delta page.

The first delta record is used to record the first data corresponding to the first write operation, and the first pointer of the target entry in the base page points to the first address information of the first delta record. As shown in FIG. 1, subsequent to creating the first delta record inode-1′, the first pointer “next” of the target entry inode-1 in the base page points to the first address information of the first delta record inode-1′. That is, the offset position of the first delta record inode-1′.

In some non-limiting embodiments, subsequent to the operation of creating the first delta record in the delta page, the method further includes:
a mapping relationship between the target entry and the first delta record is recorded in the mapping table; the mapping relationship includes the first address information of the first delta record.

In some non-limiting embodiments, as shown in FIG. 4, if a write operation is performed on the target entry, such as the key (key=a) of the target entry, the target entry a is searched in a node memory corresponding to a node 3 in the B+ tree structure. If there does not exist the target entry a in the node memory, a determination regarding whether there exists a record of the target entry a in the mapping table needs to further performed.

In a case where the target entry a is neither existed in the node 3 nor found in the mapping table, it indicates that the written data corresponding to the target entry a is first added new data. Then, the first delta record inode-1′ is created in the delta page, and a mapping relationship between the target entry and the first delta record inode-1′ in the mapping table, and a pointer “next” in this mapping relationship points to the address information (e.g., the offset position) of the first delta record. The pointer “next” in the mapping table shown in FIG. 4 points to the offset position of the first delta record inode-1′ in the delta page (as indicated by the solid arrow in the mapping table in FIG. 4).

Alternatively, the target entry a is added to the mapping table and the first data corresponding to the target entry a, such as value=456, is written into the delta page, when the first write operation is detected. The first data written into the delta page is denoted as the first delta record, and the offset position of the first delta record is stored in the mapping table where the offset position maps in association with the target entry a.

In some non-limiting embodiments, in a case where the target entry exists in the node 3, however, the target entry does not exist in the mapping table, it indicates that the target entry a has not been updated. In this case, a first delta record inode-1′ is created in the delta page, a mapping relationship between the target entry and the first delta record is added to the mapping table, and a pointer “next” in this mapping relationship points to the address information (e.g., the offset position) of the first delta record. The pointer “next” in the mapping table shown in FIG. 4 points to the offset position of the first delta record inode-1′ in the delta page (as indicated by the solid arrow in the mapping table in FIG. 4).

In a step of S303, a second delta record is created in the delta page when a second write operation on the target entry is detected, where the second delta record is used to record the second data corresponding to the second write operation.

In the embodiment of the present disclosure, in a case where multiple update operations on the data corresponding to the target entry of the base page, such as a second write operation for writing the first data into the target entry, are received by the electronic device, the electronic device creates another delta record, such as the second delta record inode-1″, in the delta page corresponding to the created target entry.

In some non-limiting embodiments, the second delta record is used to record the second data corresponding to the second write operation, and the first pointer of the target entry in the base page points to the second address information of the second delta record. As shown in FIG. 1, subsequent to creating the second delta record inode-1″, the first pointer “next” of the target entry inode-1 in the base page points to the second address information of the second delta record. That is, the offset position of the second delta record inode-1″, the second pointer of the second delta record points to the first address information of the first delta record, that is, the offset position of the first delta record inode-1′.

In some non-limiting embodiments, subsequent to the operation of creating the second delta record in the delta page, the method further includes: updating the first address information in the mapping relationship to the second address information of the second delta record.

In some non-limiting embodiments, the first delta record serves as the previous data update version of the second delta record. As shown in FIG. 4, if an update (such as a write operation) is performed on a target entry, such as the key (key=a) of the target entry, the target entry a is searched in the node memory corresponding to the node 3 in the B+ tree structure. If there does not exist the target node a, a determination regarding whether there exists a record of the target entry a in the mapping table needs to be further performed.

In some non-limiting embodiments, in a case where the target entry a does not exist in the node 3, however, the node 3 exists in the mapping table, it indicates that the written data corresponding to the target entry a is first added new data, a second delta record inode-1″ is created in the delta page, and the mapping relationship between the target entry and the first delta record in the mapping table is updated to the mapping relationship between the target entry and the second delta record, that is, the pointer “next” in the mapping relationship points to the address information (e.g., the offset position) of the second delta record. As shown in FIG. 4, the pointer “next” in the mapping table indicates the offset position of the second delta record inode-1″ in the delta page (as indicated by the dashed arrow in the mapping table in FIG. 4).

In some non-limiting embodiments, in a case where the target entry a exists in the node 3 and there exists a mapping relationship record corresponding to the target entry a in the mapping table, it indicates that the data of “a” has been updated. In this case, when a write operation is performed to update the data again, a second delta record inode-1″ is added to the delta page, and the pointer of this second delta record inode-1″ points to the address information of the delta record of the previous version, that is, the offset position of the first delta record inode-1′. The pointer “next” in the mapping table is updated so as to point to the offset position of the second delta record inode-1″. Thus, the mapping relationship in the mapping table indicates the latest version of data corresponding to the entry.

In some non-limiting embodiments, the method further includes:
The data recorded in the base page and the data recorded in the delta page are merged to obtain a new base page in accordance with a determination that the number of mapping relationships recorded in the mapping table exceeds a first threshold. Alternatively, the data recorded in the base page and the data recorded in the delta page are merged to obtain a new base page, in accordance with a determination that a size of the delta page exceeds a second threshold.

In some non-limiting embodiments, in order to optimize a reading efficiency and reduce a workload of data merge, a global merge operation is performed based on the number of entries in the mapping relationship recorded in the mapping table or the size of the data stored in the delta page. If the number of entries in the mapping relationship recorded in the mapping table exceeds the first threshold (e.g., 100 entries), or if a delta page corresponding to an entry exceeds a second threshold (e.g., 4 KB), the data stored in the delta page of the entry is merged with the data in the base page.

In some non-limiting embodiments, during the data merging process, entries may also be sorted based on the keys of the original entries to prevent an occurrence of duplicate data with identical key value.

In some non-limiting embodiments, merging the data recorded in the base page with the data recorded in the delta page includes: merging the data recorded in the latest delta record corresponding to the target entry in the delta page into the base page to obtain a new base page.

In some non-limiting embodiments, the latest version of data in the delta page, which corresponds to the plurality of entries in the base page, is merged into the base page to ensure that the data of the these entries remains up-to-date, thereby generating a new base page. The historical data corresponding to the plurality of entries in the delta page is deleted, and space occupation of the disk is reduced accordingly.

In some non-limiting embodiments, merging the data recorded in the base page with the data recorded in the delta page includes: determining the latest delta record corresponding to the target entry in the delta page based on the address information recorded in the mapping table, merging the data recorded in the latest delta record into the base page to obtain a new base page.

In some non-limiting embodiments, the delta page further includes new added data (i.e., the data that does not exist in the node corresponding to the base page). The address information corresponding to this new added data is recorded in the mapping table. During the merging process of the delta page corresponding to the entry, the address information (e.g., the offset position indicated by the pointer field next) corresponding to the entry recorded in the mapping relationship in the mapping table may also be combined to obtain the latest delta record corresponding to this address information, which records the data corresponding to the newly added data. This data is merged into the base page to obtain a new base page. Thus, the latest delta record corresponding to the entry in the delta page may be directly located, traversing the linked lists of delta pages layer by layer is avoided, and the efficiency of merging is improved. A global merge is performed on the data keys (e.g., key=a) in the base page, the delta page, and the mapping table to ensure that the generated new base page data is complete and ordered.

In some non-limiting embodiments, subsequent to the operation of merging the data recorded in the base page with the data recorded in the delta page to obtain the new base page, the method further includes:
When the size of the new base page exceeds the third threshold, a splitting operation is performed on the node data of the current node; the data split based on the splitting operation is written into the newly added node; and the index information of the newly added node is updated in the parent node of the current node.

In some non-limiting embodiments, if the size of the generated new base page exceeds the limit of the third threshold (e.g., 4 KB), a splitting operation on the current node is triggered, and the data split subsequent to the operation of writing the splitting operation into the newly added node. For example, the data exceeding 4KB is written into the new node. In this splitting operation, the keys of the entries in the new base page may be sorted, and the data corresponding to the sorting exceeding 4 KB is written into the newly added node.

For example, a storage threshold of a page is 4 entries. The data stored in the base page includes the data corresponding to entry a, entry b, entry e, and entry f, respectively. The data stored in the delta page includes the data corresponding to the entry a′, entry c, entry d, and entry g, respectively. When data is merged based on the base page, the delta page and the mapping table, the data corresponding to entry a′, entry b, entry c, entry d, entry e, entry f and entry g may be obtained. Since a corresponding page storage threshold of each node is 4 entries, the merged data is split, that is, the data corresponding to the entry a′, the entry b, the entry c, and the entry d are stored in the disk page of the first node, and the data corresponding to the entry e, the entry f, and the entry g are stored in the disk page corresponding to the second node. The index information of the first node and the second node is added to the parent node. The first node and the second node are child nodes of the parent node, they are nodes at the same hierarchy in the B+ tree structure.

Correspondingly, subsequent to the operation of writing the split data into the newly added node, the index information of the newly added node is updated in the root node corresponding to the current node. This index information includes a disk page identifier (Page ID, pgid) of the newly added node. In some non-limiting embodiments, the update of index information in the parent node also adopts an incremental update method to avoid repeated writes and unnecessary disk I/O operations.

According to the embodiments of the present disclosure, the latest delta records are directly located through pointers, the high workload of traversing the entire delta page linked list is avoided. Based on the index support provided by the mapping table, the efficiency of querying data is optimized. When updating data, it only needs to write the delta records, without the need to repeatedly write the entire disk page. Accordingly, the overhead of disk I/O operations are reduced. The latest incremental data is quickly located based on threshold-based determination, delayed merging, and the pointer based on the mapping table, the high cost of layer-by-layer merging is lowered, and unnecessary traversal and merging during the data merging process are reduced. Based on the mapping table and the linked list structure corresponding to each entry in the delta page, data tracing of multiple versions of data with the same key and high-concurrency updates may be supported. The organization method of incremental data of the single linked list structure corresponding to each entry and dynamic delay are also suitable for the read-write requirements of high-concurrency scenarios, thereby reducing conflicts between storage and performance. According to the incremental update organization method of the single linked list, dynamic expansion is supported, the problem of write amplification is alleviated. Combining pointer positioning during reading and writing avoids frequent rewrites and improves read-write performance; keys are sorted during the data merging process to ensure data consistency and avoid repeated traversal and merging operations.

It should be appreciated that, the values of serial numbers of the steps in the aforesaid embodiments do not indicate an order of execution sequences of the steps; instead, the execution sequences of the steps should be determined by functionalities and internal logic of the steps, and thus shouldn't be regarded as limitation to implementation processes of the embodiments of the present disclosure.

FIG. 5 illustrates a schematic diagram of hardware structure of an electronic device 6.

As shown in FIG. 5, the electronic device 6 in this embodiment includes: at least one processor 60 (only one processor is shown in FIG. 5), a storage 61, and a computer program 62 stored in the storage 61 and executable by the processor 60. The processor 60 is configured to, when executing the computer program 62, implement the steps in the method embodiments, such as the steps S301-D303 in FIG. 3.

It should be appreciated that the structure illustrated in the embodiments of the present disclosure does not constitute a specific limitation on the electronic device 6. In other non-limiting embodiments of the present disclosure, the electronic device 6 may include more or fewer components than the components shown in FIG. 5, or combine certain components, or split certain components, or have different component arrangements. The components shown in FIG. 5 may be implemented in hardware, software, or a combination of hardware and software.

The electronic device 6 may include, but is not limited to, a processor 60, a storage 61. A person of ordinary skill in the art may understand that, FIG. 5 is only one example of the electronic device 6, but should not be constituted as limitation to the electronic device 6, the electronic device 6 may include more or less components than the components shown in FIG. 5. Alternatively, the electronic device 6 may combine some components or different components. For example, the electronic device 6 may also include an input and output device, a network access device, a bus, etc.

The processor 60 may either be a central processing unit (Central Processing Unit, CPU), or be other general purpose processor, digital signal processor (Digital Signal Processor, DSP), application specific integrated circuit (Application Specific Integrated Circuit, ASIC), field-programmable gate array (Field-Programmable Gate Array, FPGA), or some other programmable logic devices, discrete gate or transistor logic device, discrete hardware component, etc. The general purpose processor may be a microprocessor, or be any conventional processor, etc.

A storage may also be provided in the processor 60, in order for storing instructions and data. In some non-limiting embodiments, the storage in the processor 60 is a cache. This cache store instructions or data that have just been used or reused by the processor 60. If the processor 60 needs to use the instruction or the data again, the processor 60 may direct invoke the instruction or the data from the cache. In this way, repeated access is avoided, the waiting time of the processor 60 is reduced, and the efficiency of the system is improved accordingly.

The storage 61 may be an internal storage unit of the electronic device 6, such as a hard disk or a memory of the electronic device 6. The storage 61 may also be an external storage device of the electronic device 6, such as a plug-in hard disk, a smart media card (Smart Media Card, SMC), a secure digital (Secure Digital, SD) card, a flash card (Flash Card, FC) equipped on the electronic device 6. Furthermore, the storage 61 may not only include the internal storage unit of the electronic device 6, but also include the external memory of the electronic device 6. The storage 61 is configured to store an operating system, an application program, a BootLoader, data and other procedures, such as program codes of the computer program, etc. The storage 61 may also be configured to temporarily store data that has been output or being ready to be output.

In addition, the various functional units in each of the embodiments of the present disclosure may be integrated into a single processing unit, or exist individually and physically, or two or more than two units are integrated into a single unit. The aforesaid integrated unit can either be achieved by hardware, or be achieved in the form of software functional units.

It should be noted that the structure of the aforementioned electronic device 6 is merely exemplary. The electronic device 6 may also include other physical structures, based on different application scenarios. The physical structure of the electronic device 6 is not limited herein.

In the embodiments of the present disclosure, the descriptions of the embodiments in the present disclosure are emphasized respectively. Regarding the part in some embodiments which is not described in detail, reference can be made to related descriptions in other embodiments.

A chip system is further provided in the non-limiting embodiments of the present disclosure, this chip system is applied to the electronic device 6. The chip system includes one or a plurality of processors, and the one or a plurality of processors are configured to invoke a computer instruction to cause the electronic device 6 to implement the steps in the various method embodiments described above.

A non-transitory computer-readable storage medium is further provided in the non-limiting embodiments of the present disclosure. The computer-readable storage medium stores a computer program, that, when executed by the processor of the electronic device 6, causes the processor of the electronic device 6 to implement the steps in the aforesaid various method embodiments.

A computer program product is provided in the non-limiting embodiments of the present disclosure. The computer program product is configured to, when executed by the electronic device 6, causes the electronic device 6 to implement the steps in the aforesaid various method embodiments.

When the integrated modules/unit are achieved in the form of software functional units, and are sold or used as an independent product, the integrated modules/units may be stored in a computer readable storage medium. Based on this understanding, a whole or part of flow process for implementing the method in the embodiments of the present disclosure may also be accomplished in the manner of using computer program to instruct relevant hardware. The computer program is stored in the computer-readable storage medium, when the computer program is executed by the processor, the steps in the various method embodiments described above may be implemented. The computer program includes computer program codes, which may be in the form of source code, object code, executable documents or some intermediate form, etc. The computer readable medium may include: any physical equipment or device that can carry the computer program codes, recording medium, USB flash disk, mobile hard disk, hard disk, optical disk, computer storage, read only memory (Read-Only Memory, ROM), random access memory (Random Access Memory, RAM).

The B+-tree-based data management device, the electronic device, the chip system, the computer storage medium and the computer program product provided in the embodiments of the present disclosure are all used for performing the method provided in the above embodiments. Thus, regarding the beneficial effects that can be achieved by the B+-tree-based data management device, the electronic device, the chip system, the computer storage medium and the computer program product, reference can be made to the corresponding beneficial effects of the methods provided in the above embodiments. Accordingly, the beneficial effects are not repeatedly described herein.

It should be appreciated that the above descriptions are only intended to assist the person of ordinary skill in the art in better understanding the embodiments of the present disclosure, and are not intended to limit the scope of the embodiments of the present disclosure. Based on the provided examples, the person of ordinary skill in the art may obviously make various equivalent modifications or variations. For example, some steps in the various embodiments of the method described above may be unnecessary, or alternatively, some new steps may be added. Alternatively, combinations of any two or more embodiments described above may be used. Such modifications, variations, or combined solution also fall within the scope of the embodiments of the present disclosure.

It should also be understood that the methods, situations, categories, and divisions of embodiments in this application are solely for the convenience of description and should not constitute any particular limitation. Various methods, categories, situations, and features within the embodiments may be combined without contradiction.

It should also be appreciated that in various embodiments of the present disclosure, unless specifically stated otherwise and in the absence of logical conflicts, the terminologies and/or descriptions among different embodiments are consistent and may be cross-referenced. The technical features in different embodiments may be combined to form new embodiments based on their inherent logical relationships.

The person of ordinary skill in the art may understand that, the elements and algorithm steps of each of the examples described in connection with the embodiments disclosed herein may be implemented in electronic hardware, or in combination with computer software and electronic hardware. Whether these functions are implemented by hardware or software depends on the specific application and design constraints of the technical solution. The skilled people could use different methods to implement the described functions for each particular application, however, such implementations should not be considered as going beyond the scope of the present disclosure.

The foregoing embodiments are only intended to explain the technical solutions of the present disclosure, rather than limiting the technical solutions of the present disclosure. Although the present disclosure has been described in detail with reference to these embodiments, a person of ordinary skilled in the art should understand that, the technical solutions disclosed in the embodiments may also be amended, some technical features in the technical solutions may also be equivalently replaced. The amendments or the equivalent replacements don't cause the essence of the corresponding technical solutions to be deviated from the spirit and the scope of the technical solutions in the embodiments of the present disclosure, and thus should all be included in the protection scope of the present disclosure.

In conclusion, it should be noted that the above descriptions are only the embodiments of the present disclosure, however, the protection scope of the present disclosure is not limited thereto. Any changes or substitutions within the technical scope disclosed in the present disclosure should be included in the protection scope of the present disclosure. Therefore, the protection scope of the present disclosure shall be determined by the protection scope of the claims.

What is claimed is:

1. A B+-tree-based data management method implemented by an electronic device, comprising:
writing the node data to a base page of a disk when a first write operation on a node data of a B+ tree is detected, wherein the base page contains a pointer field configured to indicate an associated delta page;
creating a first delta record in a delta page based on the base page when a first write operation on a target entry in the base page is detected, wherein the first delta record is used to record first data corresponding to the first write operation, and a first pointer of the target entry in the base page points to first address information of the first delta record; and
creating a second delta record in the delta page when a second write operation on the target entry is detected, wherein the second delta record is used to record second data corresponding to the second write operation, the first pointer of the target entry in the base page points to second address information of the second delta record, and a second pointer of the second delta record points to the first address information of the first delta record;
wherein the pointer field is configured to indicate the delta page associated with the base page.

2. The method according to claim 1, further comprising:
creating a mapping table corresponding to the base page when the node data is written into the base page of the disk; wherein the mapping table is used to record a correspondence relationship between data of the target entry in the base page and address information in the delta page.

3. The method according to claim 2, wherein subsequent to creating the first delta record in the delta page, the method further comprises:
recording a mapping relationship between the target entry and the first delta record in the mapping table, wherein the mapping relationship comprises the first address information of the first delta record;
wherein the method further comprises:
updating the first address information in the mapping relationship to the second address information of the second delta record, subsequent to the operation of creating the second delta record in the delta page.

4. The method according to claim 3, further comprising:
merging data recorded in the base page with data recorded in the delta page to obtain a new base page, in accordance with a determination that a number of mapping relationship(s) recorded in the mapping table exceeds a first threshold.

5. The method according to claim 1, further comprising:
merging data recorded in the base page with data recorded in the delta page to obtain a new base page, in accordance with a determination that a size of the delta page exceeds a second threshold.

6. The method according to claim 5, wherein the merging the data recorded in the base page with the data recorded in the delta page comprises:
merging the data recorded in a latest delta record, which corresponds to the target entry in the delta page, into the base page to obtain the new base page.

7. The method according to claim 4, wherein the merging the data recorded in the base page with the data recorded in the delta page comprises:
determining a latest delta record corresponding to the target entry in the delta page based on the address information recorded in the mapping table; and
merging data recorded in the latest delta record into the base page to obtain the new base page.

8. The method according to claim 5, wherein subsequent to merging the data recorded in the base page with the data recorded in the delta page to obtain the new base page, the method further comprises:
performing a splitting operation on the node data of a current node in accordance with a determination that a size of the new base page exceeds a third threshold;
writing data split based on the splitting operation into a newly added node; and
updating index information of the newly added node in a parent node of the current node.

9. An electronic device, comprising at least one processor and a storage connected in communication with the at least one processor; the storage storing a computer program executed by the at least one processor,
wherein when executing the computer program stored in the storage, the processor is configured to:
write the node data to a base page of a disk when a first write operation on a node data of a B+ tree is detected, wherein the base page contains a pointer field configured to indicate an associated delta page;
create a first delta record in a delta page based on the base page when a first write operation on a target entry in the base page is detected, wherein the first delta record is used to record first data corresponding to the first write operation, and a first pointer of the target entry in the base page points to first address information of the first delta record; and
create a second delta record in the delta page when a second write operation on the target entry is detected, wherein the second delta record is used to record second data corresponding to the second write operation, the first pointer of the target entry in the base page points to second address information of the second delta record, and a second pointer of the second delta record points to the first address information of the first delta record;
wherein the pointer field is configured to indicate the delta page associated with the base page.

10. A computer program product, comprising a computer program that, when executed by a processor of an electronic device, causes the processor of the electronic device to perform the operations of the method according to claim 1.

11. The electronic device according to claim 9, wherein the processor is further configured to create a mapping table corresponding to the base page when the node data is written into the base page of the disk; wherein the mapping table is used to record a correspondence relationship between data of the target entry in the base page and address information in the delta page.

12. The electronic device according to claim 11, wherein when the first delta record in the delta page is created, the processor is further configured to record a mapping relationship between the target entry and the first delta record in the mapping table, wherein the mapping relationship comprises the first address information of the first delta record;
wherein when the second delta record in the delta page is created, the processor is further configured to update the first address information in the mapping relationship to the second address information of the second delta record.

13. The electronic device according to claim 12, wherein the processor is further configured to merge data recorded in the base page with data recorded in the delta page to obtain a new base page, in accordance with a determination that a number of mapping relationship(s) recorded in the mapping table exceeds a first threshold.

14. The electronic device according to claim 9, wherein the processor is further configured to merge data recorded in the base page with data recorded in the delta page to obtain a new base page, in accordance with a determination that a size of the delta page exceeds a second threshold.

15. The electronic device according to claim 13, wherein the processor is further configured to merge data recorded in the base page with data recorded in the delta page to obtain a new base page, in accordance with a determination that a size of the delta page exceeds a second threshold;
wherein the processor is further configured to merge the data recorded in a latest delta record corresponding to the target entry in the delta page into the base page to obtain the new base page.

16. The electronic device according to claim 13, wherein the processor is further configured to determine a latest delta record corresponding to the target entry in the delta page based on the address information recorded in the mapping table, and merge data recorded in the latest delta record into the base page to obtain the new base page.

17. The electronic device according to claim 13, wherein when the data recorded in the base page is merged with the data recorded in the delta page to obtain the new base page, the processor is further configured to:
perform a splitting operation on the node data of a current node in accordance with a determination that a size of the new base page exceeds a third threshold;
write data split based on the splitting operation into a newly added node; and
update index information of the newly added node in a parent node of the current node.
